(19) United States
(12) Patent Application Publication
(10) Pub. No.: US 2026/0203526 A1
(43) Pub. Date: Jul. 16, 2026

(54) INFORMATION PROCESSING SYSTEM AND INFORMATION PROCESSING METHOD

(71) Applicant: Semiconductor Energy Laboratory Co., Ltd., Atsugi-shi (JP)

(72) Inventors: Junpei MOMO, Sagamihara (JP); Hiroki HOSOSHIMA, Atsugi (JP); Aoi NAKAMURA, Atsugi (JP)

(21) Appl. No.: 19/433,137

(22) Filed: Dec. 26, 2025

(30) Foreign Application Priority Data
Jan. 16, 2025 (JP) 2025-005904

(51) Int. Cl. G06F 40/40

(52) U.S. Cl. CPC G06F 40/40

(57) ABSTRACT

An information processing system including a first component, a second component, and a third component is provided. The first component receives opinions and a response-prompting word. The second component receives prompts and prompts responses. A large language model generates the response-prompting word and the opinions in accordance with the prompts. The third component receives the opinions, transmits the prompts, and receives the response-prompting word. In addition, the third component creates the prompts. The prompt includes background information and common understanding, and an idea possessing novelty and non-obviousness is extracted so that the patentability can be increased. The system allows a user to input the opinion and extract the idea possessing novelty and non-obviousness. The user can engage in dialogue while playing the role of a player and deepen user's thinking.

### BACKGROUND OF THE INVENTION

### Field of the Invention

One embodiment of the present invention relates to an information processing system, an information processing method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Thus, more specifically, examples of the technical field of one embodiment of the present invention disclosed in this specification include an information processing device, a semiconductor device, a memory device, a driving method thereof, and a manufacturing method thereof.

### Description of the Related Art

In recent years, language models using neural networks have been actively developed, and especially large language models (LLM) have attracted attention. A large language model is a natural language processing model learned using a large amount of data. With a large language model, for example, a communication model that gives an answer to a user's instruction can be achieved. In Non-Patent Document 1, generative pre-trained transformer 4 (GPT-4, registered trademark) is disclosed as a large language model, and ChatGPT is disclosed as a communication model.

By utilizing a large language model, the capability of a natural language processing model has been significantly increased. On the other hand, owing to the expansion of the language model, it is difficult to incorporate and operate a language model on one's own from the aspect of facilities and costs. Accordingly, utilizing a service that provides a language model, a service that uses a language model (e.g., AI chatting service and AI agent service), or the like is one of the utility forms of a language model.

### Reference

[Non-Patent Document 1] Summary of ChatGPT/GPT-4 Research and Perspective Towards the Future of Large Language Models, Yiheng Liu et al., (submitted on 4 April, 2023) [online], Internet URL: https://arxiv.org/abs/2304.01852

### SUMMARY OF THE INVENTION

One object of one embodiment of the present invention is to provide a novel information processing system that is highly convenient, useful, or reliable. Another object of one embodiment of the present invention is to provide a novel information processing method that is highly convenient, useful, or reliable. Another object of one embodiment of the present invention is to provide a novel information processing system, a novel information processing method, or a novel semiconductor device.

Note that the description of these objects does not preclude the existence of other objects. One embodiment of the present invention does not need to achieve all these objects. Other objects will be apparent from and can be derived from the description of the specification, the drawings, the claims, and the like.

(1) One embodiment of the present invention is an information processing system including a function of receiving a first opinion and creating a first prompt, a second prompt, a third prompt, and a fourth prompt, and a function of receiving a response-prompting word, a second opinion positive about the first opinion, and a third opinion negative about the first opinion from a large language model and transmitting the response-prompting word.

The first prompt includes a procedure for generating the response-prompting word to prompt a player to respond. The second prompt includes a procedure for generating the response-prompting word in consideration of the first opinion, the second opinion, or the third opinion. The third prompt includes a procedure for generating a second opinion. The fourth prompt includes a procedure for generating a third opinion.

The large language model has a function of generating the response-prompting word in accordance with the first prompt and the second prompt, a function of generating a new second opinion in accordance with the third prompt, and a function of generating a new third opinion in accordance with the fourth prompt.

(2) One embodiment of the present invention is an information processing system including a first component, a second component, and a third component.

The first component has a function of receiving a first opinion and transmitting it to the third component and a function of receiving a response-prompting word and providing it.

The second component has a function of receiving a first prompt, a second prompt, a third prompt, and a fourth prompt and transmitting the response-prompting word, a second opinion, and a third opinion to the third component and a function of performing processing using a large language model. The large language model has a function of generating the response-prompting word in accordance with the first prompt and the second prompt, a function of generating the second opinion in accordance with the third prompt, and a function of generating the third opinion in accordance with the fourth prompt. The response-prompting word is a word for prompting any one of a first player, a second player, and a third player to respond.

The third component has a function of receiving the first opinion from the first component and transmitting the first prompt, the second prompt, the third prompt, and the fourth prompt to the second component, a function of receiving the response-prompting word, the second opinion, and the third opinion from the second component, and a function of transmitting the response-prompting word to the first component when the first player is prompted to respond with the response-prompting word.

The third component includes a first subcomponent. The first subcomponent has a function of creating the first prompt, a function of creating the second prompt when receiving the first opinion, the second opinion, or the third opinion, a function of creating the third prompt when the second player is prompted to respond with the response-prompting word, and a function of creating the fourth prompt when the third player is prompted to respond with the response-prompting word.

The first prompt includes a first instruction and first background information. The first instruction includes a procedure for generating the response-prompting word on the basis of the first background information to prompt the first player to respond. The first background information includes information specifying common understanding and orientation of the response-prompting word. The common understanding includes a purpose of increasing patentability by extracting an idea possessing novelty and non-obviousness from the first opinion of the first player in collaboration with the other players.

The second prompt includes a second instruction and any one of the first opinion, the second opinion, and the third opinion. The second instruction includes a procedure for selecting, on the basis of the first background information, one from the first player, the second player, and the third player as a target to be prompted to respond and generating the response-prompting word in consideration of the first opinion, the second opinion, or the third opinion.

The third prompt includes a third instruction, second background information, and any one of the first opinion, the second opinion, and the third opinion. The third instruction includes a procedure for generating a new second opinion in consideration of the first opinion, the second opinion, or the third opinion on the basis of the second background information. The second background information includes information specifying the common understanding and orientation of the second opinion.

The fourth prompt includes a fourth instruction, third background information, and any one of the first opinion, the second opinion, and the third opinion. The fourth instruction includes a procedure for generating a new third opinion in consideration of the first opinion, the second opinion, or the third opinion on the basis of the third background information. The third background information includes information specifying the common understanding and orientation of the third opinion.

Thus, the user of the information processing system of one embodiment of the present invention can input the first opinion to the first component, for example. The information processing system of one embodiment of the present invention can extract the idea possessing novelty and non-obviousness from the first opinion. The first opinion can be refined into the idea possessing novelty and non-obviousness. Patentability can be increased. The user of the information processing system of one embodiment of the present invention can play the role of the first player, for example. The first player can engage in dialogue with the second player and the third player. The user of the information processing system of one embodiment of the present invention can deepen user's thinking through the dialogue, for example. The information processing system of one embodiment of the present invention can extract the idea possessing novelty and non-obviousness and select one from the first player, the second player, and the third player to ask the selected player for the player's opinion for the purpose of increasing patentability. As a result, a novel information processing system that is highly convenient, useful, or reliable can be provided.

(3) Another embodiment of the present invention is the information processing system in which the first component has a function of receiving a dialogue record and specifications and providing the dialogue record and the specifications. The dialogue record includes the response-prompting word, the first opinion, the second opinion, and the third opinion. The specifications include an item and a field corresponding to the item. The item is an item required for the idea possessing novelty and non-obviousness.

The second component has a function of receiving the second prompt and transmitting a value to the third component. The large language model has a function of generating the value in accordance with the second prompt.

The third component has a function of receiving the value from the second component and sharing it in the third component and a function of transmitting the dialogue record and the specifications to the first component.

The third component includes a second subcomponent. The second subcomponent has a function of creating the dialogue record and a function of storing the value in the field and creating the specifications.

The second instruction includes a procedure for generating the value corresponding to the item in consideration of the first opinion, the second opinion, and the third opinion.

Thus, the information processing system of one embodiment of the present invention can extract the idea possessing novelty and non-obviousness from the first opinion and format the specifications. As a result, a novel information processing system that is highly convenient, useful, or reliable can be provided.

(4) Another embodiment of the present invention is the information processing system in which the first component has a function of receiving approval information and transmitting it to the third component. The third component has a function of receiving the approval information and transmitting the dialogue record and the specifications to the first component.

Thus, the user of the information processing system can input the approval information to the first component and terminate the dialogue with the second player and the third player, for example. As a result, a novel information processing system that is highly convenient, useful, or reliable can be provided.

(5) Another embodiment of the present invention is the information processing system in which the third component has a function of measuring elapsed time. When the elapsed time after transmitting the response-prompting word to prompt the first player to respond to the first component overruns set time, the first subcomponent has a function of adding the overrun of the set time to the first background information and creating the second prompt again.

Thus, when the user of the information processing system of one embodiment of the present invention is at a loss for a response, the information processing system of one embodiment of the present invention can select one from the first player, the second player, and the third player and generate the response-prompting word again, for example. As a result, a novel information processing system that is highly convenient, useful, or reliable can be provided.

(6) Another embodiment of the present invention is the information processing system in which the third component includes a third subcomponent. The third subcomponent has a function of performing processing using a database, a function of collecting first information from the database and adding the first information to the second background information, and a function of collecting second information from the database and adding the second information to the third background information. The first information includes positive information on novelty or non-obviousness. The second information includes negative information on novelty or non-obviousness.

Thus, the information processing system of one embodiment of the present invention can generate the second opinion positive about novelty and non-obviousness with reference to prior art documents. Furthermore, the information processing system of one embodiment of the present invention can generate the third opinion negative about novelty and non-obviousness with reference to prior art documents. As a result, a novel information processing system that is highly convenient, useful, or reliable can be provided.

(7) Another embodiment of the present invention is the information processing system in which the first background information includes a setting for imitating actions and words of a facilitator who prompts players to make remarks, summarizes their opinions, and leads to a conclusion when the response-prompting word is generated.

The second background information includes a setting for imitating actions and words of a patent attorney who focuses on novelty and non-obviousness of the idea to point out good aspects when the second opinion is generated.

The third background information includes a setting for imitating actions and words of a patent attorney who focuses on novelty and non-obviousness of the idea to point out objection when the third opinion is generated.

Thus, the information processing system of one embodiment of the present invention can provide a constructive dialogue environment for the user of the information processing system, for example. As a result, a novel information processing system that is highly convenient, useful, or reliable can be provided.

(8) One embodiment of the present invention is an information processing method including a first step, a second step, a third step, a fourth step, a fifth step, a sixth step, a seventh step, an eighth step, a ninth step, a tenth step, an eleventh step, a twelfth step, a thirteenth step, a fourteenth step, and a fifteenth step.

In the first step, a first component transmits a first prompt to a second component. The first component includes a first subcomponent. The first subcomponent has a function of creating the first prompt. The first prompt includes a first instruction and first background information. The first instruction includes a procedure for generating a response-prompting word on the basis of the first background information to prompt a first player to respond. The first background information includes information specifying common understanding and orientation of the response-prompting word. The common understanding includes a purpose of increasing patentability by extracting an idea possessing novelty and non-obviousness from a first opinion of the first player in collaboration with the other players.

In the second step, the second component receives the first prompt and generates the response-prompting word to prompt the first player to respond using a large language model.

In the third step, the second component transmits the response-prompting word to prompt the first player to respond to the first component.

In the fourth step, the first component receives the response-prompting word to prompt the first player to respond and transmits it to a third component.

In the fifth step, the third component receives the response-prompting word to prompt the first player to respond and provides it.

In the sixth step, the third component receives the first opinion and transmits it to the first component.

In the seventh step, the first component receives the first opinion and shares it in the first component.

In the eighth step, the first subcomponent creates a second prompt and transmits it to the second component. The second prompt includes a second instruction and any one of the first opinion, a second opinion, and a third opinion. The second instruction includes a procedure for selecting, on the basis of the first background information, one from the first player, a second player, and a third player as a target to be prompted to respond and generating the response-prompting word in consideration of the first opinion, the second opinion, or the third opinion.

In the ninth step, the second component receives the second prompt and generates the response-prompting word using the large language model.

In the tenth step, the second component transmits the response-prompting word to the first component.

In the eleventh step, the first component receives the response-prompting word. When the first player is prompted to respond with the response-prompting word, the response-prompting word is transmitted to the third component, and the fifth step follows after the eleventh step. When the second player is prompted to respond with the response-prompting word and when the third player is prompted to respond with the response-prompting word, the twelfth step follows after the eleventh step.

In the twelfth step, the first subcomponent creates a third prompt and transmits it to the second component when the second player is prompted to respond with the response-prompting word. The first subcomponent creates a fourth prompt and transmits it to the second component when the third player is prompted to respond with the response-prompting word.

The third prompt includes a third instruction, second background information, and any one of the first opinion, the second opinion, and the third opinion. The third instruction includes a procedure for generating a new second opinion in consideration of the first opinion, the second opinion, or the third opinion on the basis of the second background information. The second background information includes information specifying the common understanding and orientation of the second opinion.

The fourth prompt includes a fourth instruction, third background information, and any one of the first opinion, the second opinion, and the third opinion. The fourth instruction includes a procedure for generating a new third opinion in consideration of the first opinion, the second opinion, or the third opinion on the basis of the third background information. The third background information includes information specifying the common understanding and orientation of the third opinion

In the thirteenth step, the second component receives the third prompt or the fourth prompt, generates the second opinion using the large language model when the second player is prompted to respond with the response-prompting word, and generates the third opinion using the large language model when the third player is prompted to respond with the response-prompting word.

In the fourteenth step, the second component transmits the second opinion or the third opinion to the first component

In the fifteenth step, the first component receives the second opinion or the third opinion and shares it in the first component. The eighth step follows after the fifteenth step.

Thus, the user of the information processing system of one embodiment of the present invention can input the first opinion to the third component, for example. The information processing system of one embodiment of the present invention can extract the idea possessing novelty and non-obviousness from the first opinion. The first opinion can be refined into the idea possessing novelty and non-obviousness. Patentability can be increased. The user of the information processing system of one embodiment of the present invention can play the role of the first player, for example. The first player can engage in dialogue with the second player and the third player. The user of the information processing system of one embodiment of the present invention can deepen user's thinking through the dialogue, for example. The information processing system of one embodiment of the present invention can extract the idea possessing novelty and non-obviousness and select one from the first player, the second player, and the third player to ask the selected player for the player's opinion for the purpose of increasing patentability. As a result, a novel information processing method that is highly convenient, useful, or reliable can be provided.

(9) Another embodiment of the present invention is the information processing method further including a sixteenth step, a seventeenth step, an eighteenth step, and a nineteenth step. The second instruction includes a procedure for generating a value corresponding to an item in consideration of the first opinion, the second opinion, and the third opinion.

The sixteenth step, the seventeenth step, the eighteenth step, and the nineteenth step are between the eleventh step and the twelfth step.

In the ninth step, the second component receives the second prompt and generates the value using the large language model.

In the tenth step, the second component transmits the value to the first component.

In the eleventh step, the first component receives the value and shares it in the first component. The sixteenth step follows after the eleventh step. The first component includes a second subcomponent.

In the sixteenth step, the second subcomponent stores the value in a field and creates specifications. The specifications include the item and the field corresponding to the item. The item is an item required for the idea possessing novelty and non-obviousness.

In the seventeenth step, the second subcomponent creates a dialogue record. The dialogue record includes the response-prompting word, the first opinion, the second opinion, and the third opinion.

In the eighteenth step, the second subcomponent shares the specifications and the dialogue record in the first component and transmits them to the third component.

In the nineteenth step, the third component provides the specifications and the dialogue record. The twelfth step follows after the nineteenth step.

Thus, the information processing system of one embodiment of the present invention can extract the idea possessing novelty and non-obviousness from the first opinion and format the specifications. As a result, a novel information processing method that is highly convenient, useful, or reliable can be provided.

(10) Another embodiment of the present invention is the information processing method further including a twentieth step and a twenty-first step. The twentieth step and the twenty-first step follow after the sixth step.

In the sixth step, the third component transmits approval information to the first component when receiving the approval information. The twentieth step follows after the sixth step.

In the twentieth step, the first component receives the approval information and transmits the specifications and the dialogue record to the third component.

In the twenty-first step, the third component provides the specifications and the dialogue record.

Thus, the user of the information processing system can input the approval information to the third component and terminate the dialogue with the second player and the third player, for example. As a result, a novel information processing method that is highly convenient, useful, or reliable can be provided.

One embodiment of the present invention can provide a novel information processing system that is highly convenient, useful, or reliable. Another embodiment of the present invention can provide a novel information processing method that is highly convenient, useful, or reliable. Another embodiment of the present invention can provide a novel information processing system, a novel information processing method, or a novel semiconductor device.

Note that the description of these effects does not preclude the existence of other effects. One embodiment of the present invention does not need to have all these effects. Other effects will be apparent from and can be derived from the description of the specification, the drawings, the claims, and the like.

### BRIEF DESCRIPTION OF THE DRAWINGS

FIG. 1 illustrates a configuration of an information processing system of an embodiment.

FIG. 2 illustrates a configuration of a component used in an information processing system of an embodiment.

FIG. 3 illustrates a configuration of a prompt used in an information processing system of an embodiment.

FIGS. 4A to 4C each illustrate a configuration of a prompt used in an information processing system of an embodiment.

FIGS. 5A to 5C each illustrate a configuration of a prompt used in an information processing system of an embodiment.

FIGS. 6A to 6C each illustrate a configuration of a prompt used in an information processing system of an embodiment.

FIG. 7 illustrates a configuration of information used in an information processing system of an embodiment.

FIG. 8 illustrates a configuration of an information processing device used in an information processing system of an embodiment.

FIG. 9 illustrates an information processing method of an embodiment.

FIG. 10 illustrates an information processing method of an embodiment.

FIG. 11 illustrates an information processing method of an embodiment.

### DETAILED DESCRIPTION OF THE INVENTION

An information processing system of one embodiment of the present invention includes a first component, a second component, and a third component.

The first component has a function of receiving a first opinion and transmitting it to the third component and a function of receiving a response-prompting word and providing it.

The second component has a function of receiving a first prompt, a second prompt, a third prompt, and a fourth prompt and transmitting the response-prompting word, a second opinion, and a third opinion to the third component and a function of performing processing using a large language model. The large language model has a function of generating the response-prompting word in accordance with the first prompt and the second prompt, a function of generating the second opinion in accordance with the third prompt, and a function of generating the third opinion in accordance with the fourth prompt. The response-prompting word is a word for prompting any one of a first player, a second player, and a third player to respond.

The third component has a function of receiving the first opinion from the first component and transmitting the first prompt, the second prompt, the third prompt, and the fourth prompt to the second component, a function of receiving the response-prompting word, the second opinion, and the third opinion from the second component, and a function of transmitting the response-prompting word to the first component when the first player is prompted to respond with the response-prompting word.

The third component includes a first subcomponent. The first subcomponent has a function of creating the first prompt, a function of creating the second prompt when receiving the first opinion, the second opinion, or the third opinion, a function of creating the third prompt when the second player is prompted to respond with the response-prompting word, and a function of creating the fourth prompt when the third player is prompted to respond with the response-prompting word.

The first prompt includes a first instruction and first background information. The first instruction includes a procedure for generating the response-prompting word on the basis of the first background information to prompt the first player to respond. The first background information includes information specifying common understanding and orientation of the response-prompting word. The common understanding includes a purpose of increasing patentability by extracting the idea possessing novelty and non-obviousness from the first opinion of the first player in collaboration with the other players.

The second prompt includes a second instruction and any one of the first opinion, the second opinion, and the third opinion. The second instruction includes a procedure for selecting, on the basis of the first background information, one from the first player, the second player, and the third player as a target to be prompted to respond and generating the response-prompting word in consideration of the first opinion, the second opinion, or the third opinion.

The third prompt includes a third instruction, second background information, and any one of the first opinion, the second opinion, and the third opinion. The third instruction includes a procedure for generating a new second opinion in consideration of the first opinion, the second opinion, or the third opinion on the basis of the second background information. The second background information includes information specifying the common understanding and orientation of the second opinion.

The fourth prompt includes a fourth instruction, third background information, and any one of the first opinion, the second opinion, and the third opinion. The fourth instruction includes a procedure for generating a new third opinion in consideration of the first opinion, the second opinion, or the third opinion on the basis of the third background information. The third background information includes information specifying the common understanding and orientation of the third opinion.

Thus, the user of the information processing system of one embodiment of the present invention can input the first opinion to the first component, for example. The information processing system of one embodiment of the present invention can extract the idea possessing novelty and non-obviousness from the first opinion. The first opinion can be refined into the idea possessing novelty and non-obviousness. Patentability can be increased. The user of the information processing system of one embodiment of the present invention can play the role of the first player, for example. The first player can engage in dialogue with the second player and the third player. The user of the information processing system of one embodiment of the present invention can deepen user's thinking through the dialogue, for example. The information processing system of one embodiment of the present invention can extract the idea possessing novelty and non-obviousness and select one from the first player, the second player, and the third player to ask the selected player for the player's opinion for the purpose of increasing patentability. As a result, a novel information processing system that is highly convenient, useful, or reliable can be provided. Thus, the information processing system of one embodiment of the present invention can extract the idea possessing novelty and non-obviousness from the first opinion and format the specifications. As a result, a novel information processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as "first" and "second" in this specification and the like are used in order to avoid confusion among components. Thus, the terms do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### EMBODIMENT 1

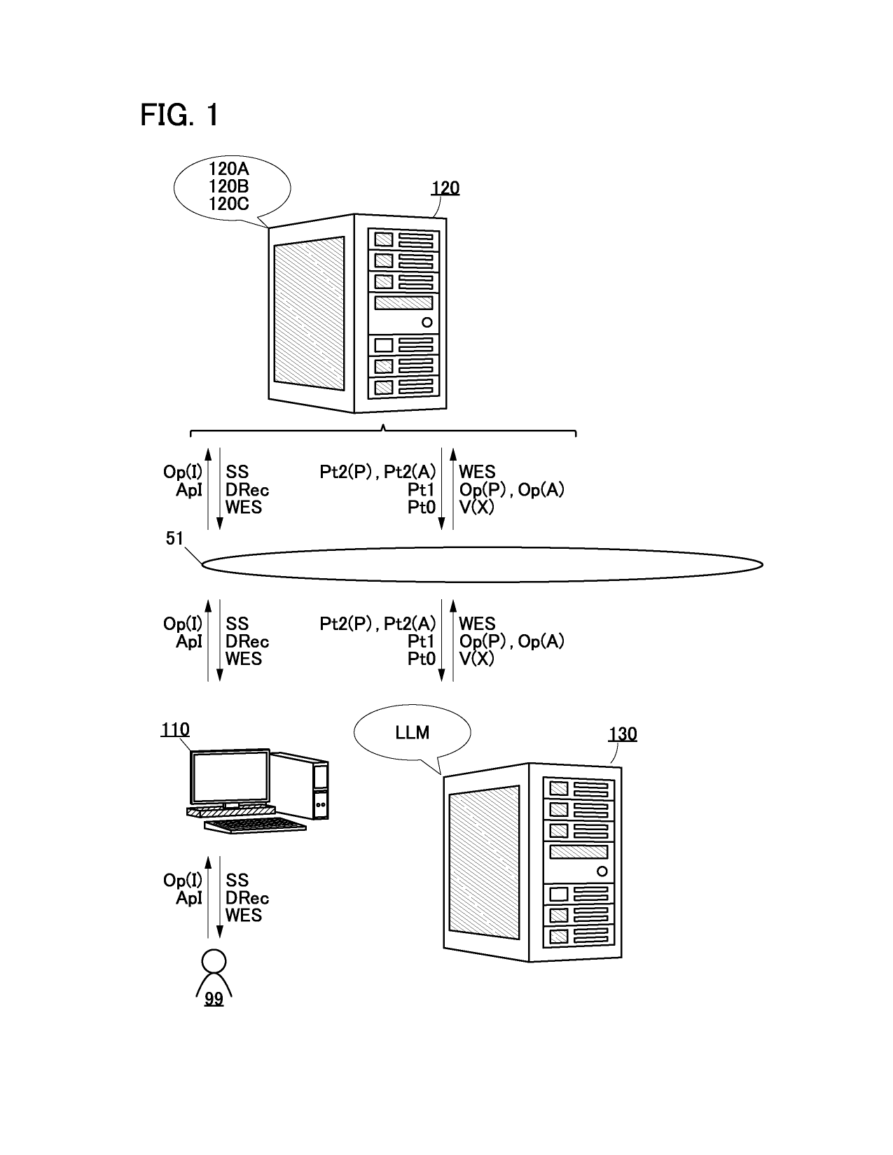

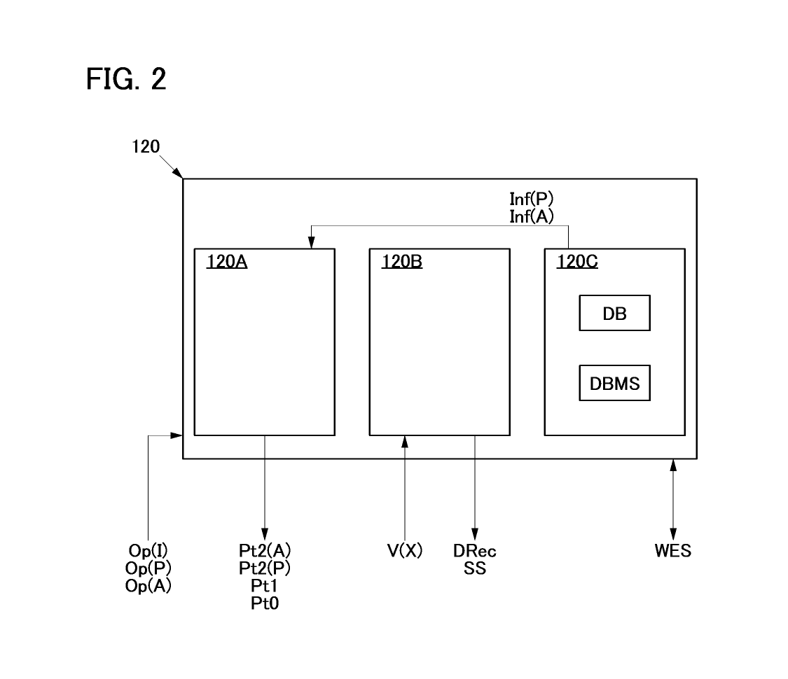

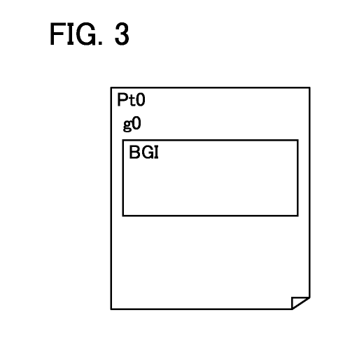

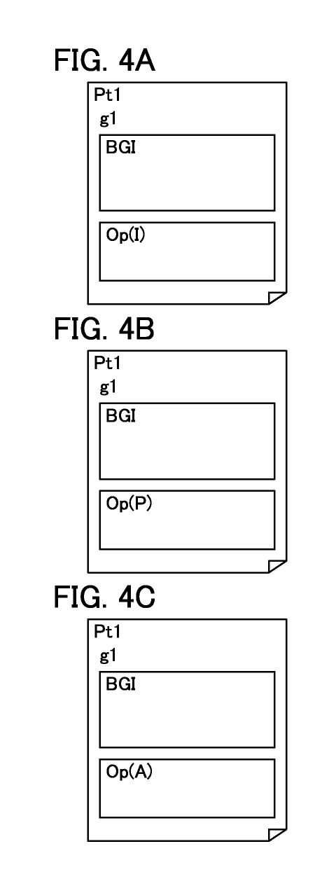

In this embodiment, an information processing system of one embodiment of the present invention will be described with reference to FIG. 1, FIG. 2, FIG. 3, FIGS. 4A to 4C, FIGS. 5A to 5C, FIGS. 6A to 6C, FIG. 7, FIG. 8, FIG. 9, FIG. 10, and FIG. 11.

FIG. 1 illustrates a configuration of the information processing system of one embodiment of the present invention.

FIG. 2 illustrates a configuration of a component used in the information processing system of one embodiment of the present invention.

FIG. 3 illustrates a configuration of a prompt that is transmitted and received inside the information processing system of one embodiment of the present invention.

FIGS. 4A to 4C each illustrate a configuration of a prompt that is transmitted and received inside the information processing system of one embodiment of the present invention.

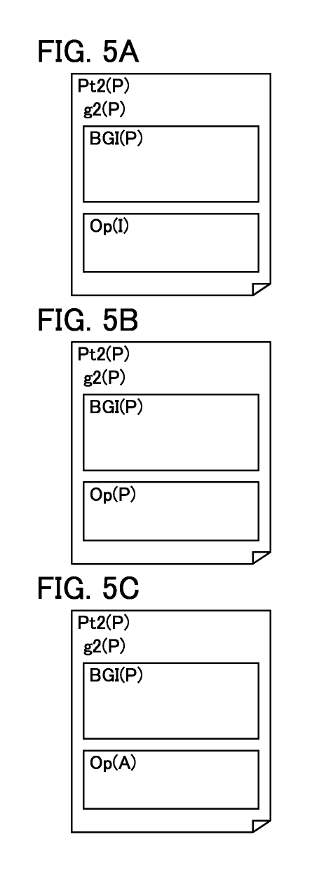

FIGS. 5A to 5C each illustrate a configuration of a prompt that is transmitted and received inside the information processing system of one embodiment of the present invention.

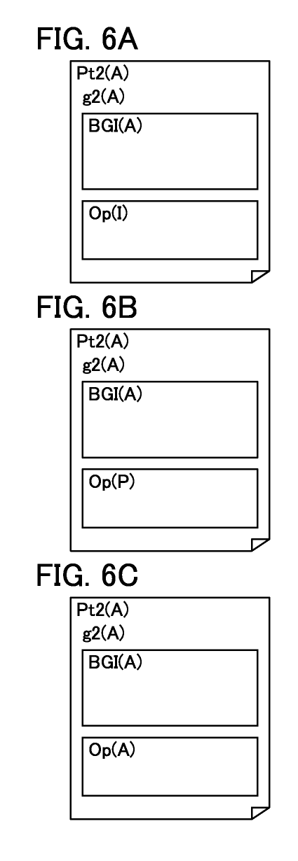

FIGS. 6A to 6C each illustrate a configuration of a prompt that is transmitted and received inside the information processing system of one embodiment of the present invention.

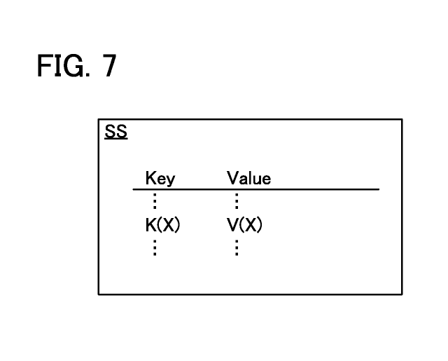

FIG. 7 illustrates a configuration of specifications that are created by the information processing system of one embodiment of the present invention.

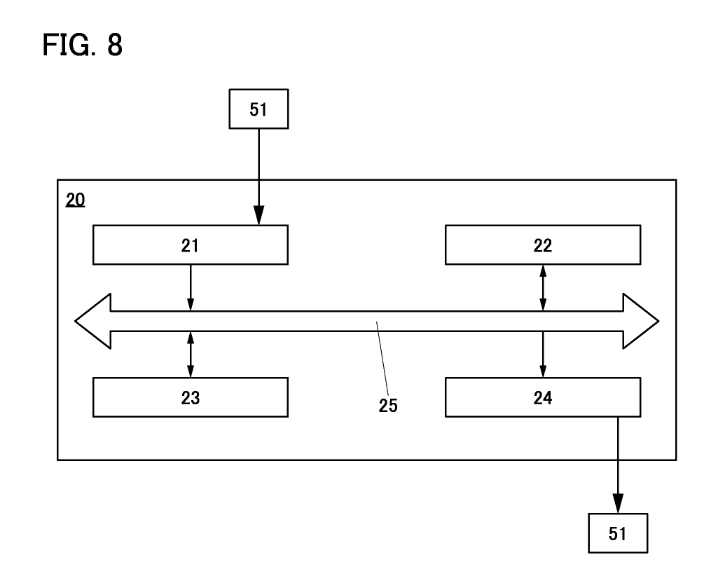

FIG. 8 is a block diagram illustrating a configuration of an information processing device that can be used in the information processing system of one embodiment of the present invention.

### Configuration example 1 of information processing system

The information processing system described in this embodiment includes a component 110, a component 130, and a component 120 (see FIG. 1).

An information processing device having a function of the component 110, an information processing device having a function of the component 130, and an information processing device having a function of the component 120 each include an arithmetic device and a communication device. The communication devices are connected to each other through a network 51, to form the information processing system of one embodiment of the present invention.

### Configuration example 1 of component 110

The component 110 has a function of receiving an opinion Op(I) and transmitting it to the component 120. In addition, the component 110 has a function of receiving a response-prompting word WES and providing it to a user 99 of the information processing system, for example. Specifically, with the use of an output device such as a display device, a speaker, a printer, or a memory device, the response-prompting word WES is provided to the user 99 of the information processing system.

For example, the user 99 of the information processing system inputs the opinion Op(I) to the component 110. Alternatively, the user 99 inputs a command for selecting and transmitting the opinion Op(I) stored in the memory device is input to the component 110, for example. Specifically, the user 99 of the information processing system inputs the opinion Op(I) to the component 110 using an input device such as a keyboard, a mouse, or an eye-gaze input device.

Specifically, an opinion or a suggestion on an invention idea by the user 99 of the information processing system can be used as the opinion Op(I).

### Configuration example 1 of component 130

The component 130 has a function of receiving a prompt Pt0, a prompt Pt1, a prompt Pt2(P), and a prompt Pt2(A). In addition, the component 130 has a function of transmitting the response-prompting word WES, an opinion Op(P), and an opinion Op(A) to the component 120 and a function of performing processing using a large language model LLM.

### Configuration example 1 of large language model LLM

The large language model LLM has a function of generating the response-prompting word WES in accordance with the prompt Pt0 and the prompt Pt1. In addition, the large language model LLM has a function of generating the opinion Op(P) in accordance with the prompt Pt2(P) and a function of generating the opinion Op(A) in accordance with the prompt Pt2(A).

The response-prompting word WES is a word for prompting any one of a player Inv, a player Pro, and a player Ant to respond. For example, a word for prompting the player Inv to express the opinion Op(I), a word for prompting the player Pro to express the opinion Op(P), or a word for prompting the player Ant to express the opinion Op(A) can be used as the response-prompting word WES.

As the large language model LLM, a large language model such as GPT-3 (registered trademark), GPT-3.5, GPT-4 (registered trademark), LaMDA, Llama2, or Llama3 can be used.

### Configuration example 1 of component 120

The component 120 has a function of receiving the opinion Op(I) from the component 110 and transmitting the prompt Pt0, the prompt Pt1, the prompt Pt2(P), and the prompt Pt2(A) to the component 130.

The component 120 has a function of receiving the response-prompting word WES, the opinion Op(P), and the opinion Op(A) from the component 130. The component 120 has a function of transmitting the response-prompting word WES to the component 110 when the player Inv is prompted to respond with the response-prompting word WES.

The component 120 includes a subcomponent 120A (see FIG. 2). In this specification, a structure having a single function or a plurality of functions is referred to as a component or a subcomponent for description convenience.

### Configuration example of subcomponent 120A

The subcomponent 120A has a function of creating the prompt Pt0 and a function of creating the prompt Pt1 when receiving the opinion Op(I), the opinion Op(P), or the opinion Op(A).

The subcomponent 120A has a function of creating the prompt Pt2(P) when the player Pro is prompted to respond with the response-prompting word WES. The subcomponent 120A has a function of creating the prompt Pt2(A) when the player Ant is prompted to respond with the response-prompting word WES.

### Configuration example of prompt pt0

The prompt Pt0 includes an instruction g0 and background information BGI (see FIG. 3). The instruction g0 includes a procedure for generating the response-prompting word WES on the basis of the background information BGI to prompt the player Inv to respond.

### Configuration example 1 of background information BGI

The background information BGI includes information specifying common understanding Con and orientation of the response-prompting word WES.

### Configuration example of common understanding Con

The common understanding Con includes a purpose of increasing patentability by extracting an idea possessing novelty and non-obviousness from the opinion Op(I) of the player Inv in collaboration with the other players.

For example, the text in the next paragraph can be used as the prompt Pt0.

"### The background information BGI

You are a facilitator.

Two players, who play the role of patent attorneys, and an inventor participate in a meeting where the invention is being discussed.

A player Pro, one of the patent attorney's parts, offers a positive opinion, and a player Ant, the other of the patent attorney's parts, offers a negative opinion.

### The instruction g0

Prompt the player Inv to describe the invention idea."

### Configuration example 1 of prompt Pt1

The prompt Pt1 includes an instruction g1 and any one of the opinion Op(I), the opinion Op(P), and the opinion Op(A) (see FIGS. 4A to 4C). The instruction g1 includes a procedure for selecting, on the basis of the background information BGI, one from the player Inv, the player Pro, and the player Ant as a target to be prompted to respond and generating the response-prompting word WES in consideration of the opinion Op(I), the opinion Op(P), or the opinion Op(A).

For example, the text in the next paragraph can be used as the prompt Pt1 when the opinion Op(I) is a subject of the discussion. In a dialogue record DRec, the response-prompting word WES, the opinion Op(I), the opinion Op(P), and the opinion Op(A) are recorded. In specifications SS, an item required for the idea possessing novelty and non-obviousness and a value corresponding to the item that is generated in consideration of the opinion Op(I), the opinion Op(P), and the opinion Op(A) are recorded, for example.

"### The background information BGI

You are a facilitator.

Two players, who play the role of patent attorneys, and an inventor participate in a meeting where the invention is being discussed.

A player Pro, one of the patent attorney's parts, offers a positive opinion, and a player Ant, the other of the patent attorney's parts, offers a negative opinion.

### The opinion Op(I)

### The instruction g1

Select, from the specifications SS and the dialogue record DRec, a suitable player for making a remark next and prompt the player to make a remark in consideration of the opinion Op(I)."

### Configuration example 1 of prompt Pt2P

The prompt Pt2(P) includes an instruction g2(P), background information BGI(P), and any one of the opinion Op(I), the opinion Op(P), and the opinion Op(A) (see FIGS. 5A to 5C). The instruction g2(P) includes a procedure for generating a new opinion Op(P) in consideration of the opinion Op(I), the opinion Op(P), or the opinion Op(A) on the basis of the background information BGI(P).

### Configuration example 1 of background information BGIP

The background information BGI(P) includes information specifying the common understanding Con and orientation of the opinion Op(P).

For example, the text in the next paragraph can be used as the prompt Pt2(P).

"### The background information BGI

You are a patent attorney.

Review the invention idea by the inventor, focus on its good aspects, and suggest effects, novelty, or non-obviousness of the invention. With reference to related application information, complete the invention in collaboration with the other patent attorney.

### The opinion Op(I)

### The instruction g2(P)

Make a positive remark in consideration of the opinion Op(I).

### Configuration example 1 of prompt Pt2A

The prompt Pt2(A) includes an instruction g2(A), background information BGI(A), and any one of the opinion Op(I), the opinion Op(P), and the opinion Op(A) (see FIGS. 6A to 6C). The instruction g2(A) includes a procedure for generating a new opinion Op(A) in consideration of the opinion Op(I), the opinion Op(P), or the opinion Op(A) on the basis of the background information BGI(A).

### Configuration example 1 of background information BGIA

The background information BGI(A) includes information specifying the common understanding Con and orientation of the opinion Op(A).

For example, the text in the next paragraph can be used as the prompt Pt2(A).

"### The background information BGI

You are a patent attorney.

Strictly check the invention idea by the inventor, and make a suggestion for making a robust invention that can overcome reasons for rejection or a trial for patent invalidation. With reference to related application information, complete the invention in collaboration with the other patent attorney.

### The opinion Op(P)

### The instruction g2(A)

Make a negative remark in consideration of the opinion Op(P).

Thus, the user of the information processing system of one embodiment of the present invention can input the opinion Op(I) to the component 110, for example. The information processing system of one embodiment of the present invention can extract the idea possessing novelty and non-obviousness from the opinion Op(I). The opinion Op(I) can be refined into the idea possessing novelty and non-obviousness. Patentability can be increased. The user of the information processing system of one embodiment of the present invention can play the role of the player Inv, for example. The player Inv can engage in dialogue with the player Pro and the player Ant. The user of the information processing system of one embodiment of the present invention can deepen user's thinking through the dialogue, for example. The information processing system of one embodiment of the present invention can extract the idea possessing novelty and non-obviousness and select one from the player Inv, the player Pro, and the player Ant to ask the selected player for the player's opinion for the purpose of increasing patentability. As a result, a novel information processing system that is highly convenient, useful, or reliable can be provided.

### Configuration example 2 of component 110

The component 110 has a function of receiving the dialogue record DRec and the specifications SS and providing them to the user 99 of the information processing system, for example. Specifically, with the use of an output device such as a display device, a speaker, a printer, or a memory device, the dialogue record DRec and the specifications SS are provided to the user 99 of the information processing system.

The dialogue record DRec includes the response-prompting word WES, the opinion Op(I), the opinion Op(P), and the opinion Op(A).

The specifications SS include an item K(X) and a field FLD(X) corresponding to the item K(X). The item K(X) is an item required for the idea possessing novelty and non-obviousness (see FIG. 7). Note that the item is also referred to as Key and the value corresponding to each item is also referred to as Value.

For example, items such as "Title of the Invention", "Summary of the Invention", "Technical Field", "Background Art", "Prior Art Document, "Problems to be Solved by the Invention", "Means for Solving the Problems", "Effect of the Invention", "Mode for Carrying Out the Invention", "Novelty and Non-obviousness", and "Enablement" can be used as the items of the specifications SS. A numerical value, a symbol, a character string, a text, or the like can be used as the value corresponding to each item.

### Configuration example 2 of component 130

The component 130 has a function of receiving the prompt Pt1 and transmitting a value V(X) to the component 120.

### Configuration example 2 of large language model LLM

The large language model LLM has a function of generating the value V(X) in accordance with the prompt Pt1.

### Configuration example 2 of component 120

The component 120 has a function of receiving the value V(X) from the component 130 and sharing it in the component 120 and a function of transmitting the dialogue record DRec and the specifications SS to the component 110.

The component 120 includes a subcomponent 120B (see FIG. 2).

### Configuration example of subcomponent 120B

The subcomponent 120B has a function of creating the dialogue record DRec and a function of storing the value V(X) in the field FLD(X) and creating the specifications SS.

### Configuration example 2 of prompt Pt1

The instruction g1 includes a procedure for generating the value V(X) corresponding to the item K(X) in consideration of the opinion Op(I), the opinion Op(P), and the opinion Op(A) (see FIGS. 4A to 4C). For example, the text in the next paragraph can be used as the prompt Pt1.

"### Items K

### The opinion Op(I)

### The instruction g1

Extract, from the content of the opinion Op(I), elements corresponding to the items K."

Thus, the information processing system of one embodiment of the present invention can extract the idea possessing novelty and non-obviousness from the opinion Op(I) and format the specifications SS. As a result, a novel information processing system that is highly convenient, useful, or reliable can be provided.

### Configuration example 3 of component 110

The component 110 has a function of receiving approval information ApI and transmitting it to the component 120 (see FIG. 1).

### Configuration example 3 of component 120

The component 120 has a function of receiving the approval information ApI and transmitting the dialogue record DRec and the specifications SS to the component 110.

Thus, the user of the information processing system can input the approval information ApI to the component 110 and terminate the dialogue with the player Pro and the player Ant, for example. As a result, a novel information processing system that is highly convenient, useful, or reliable can be provided.

### Configuration example 4 of component 120

The component 120 has a function of measuring elapsed time T. When the elapsed time T after transmitting the response-prompting word WES to prompt the player Inv to respond to the component 110 overruns set time, the subcomponent 120A has a function of adding the overrun of the set time to the background information BGI and creating the prompt Pt1 again.

Thus, when the user of the information processing system of one embodiment of the present invention is at a loss for a response, the information processing system of one embodiment of the present invention can select one from the player Inv, the player Pro, and the player Ant and generate the response-prompting word WES again, for example. As a result, a novel information processing system that is highly convenient, useful, or reliable can be provided.

### Configuration example 5 of component 120

The component 120 includes a subcomponent 120C (see FIG. 2).

### Configuration example of subcomponent 120C

The subcomponent 120C has a function of performing processing using a database DB. For example, a database in which prior art documents are stored can be used as the database DB. With the use of a management system DBMS, information on novelty or non-obviousness can be searched for.

The subcomponent 120C has a function of collecting information Inf(P) from the database DB and adding the information Inf(P) to the background information BGI(P). The subcomponent 120C has a function of collecting information Inf(A) from the database DB and adding the information Inf(A) to the background information BGI(A).

The information Inf(P) includes positive information on novelty or non-obviousness. The information Inf(A) includes negative information on novelty or non-obviousness.

Thus, the information processing system of one embodiment of the present invention can generate the opinion Op(P) positive about novelty and non-obviousness with reference to prior art documents. Furthermore, the information processing system of one embodiment of the present invention can generate the opinion Op(A) negative about novelty and non-obviousness with reference to prior art documents. As a result, a novel information processing system that is highly convenient, useful, or reliable can be provided.

### Configuration example 2 of background information BGI

The background information BGI includes a setting for imitating actions and words of a facilitator who prompts players to make remarks, summarizes their opinions, and leads to a conclusion when the response-prompting word WES is generated.

### Configuration example 2 of background information BGIP

The background information BGI(P) includes a setting for imitating actions and words of a patent attorney who focuses on novelty and non-obviousness of the idea to point out good aspects when the opinion Op(P) is generated.

### Configuration example 2 of background information BGIA

The background information BGI(A) includes a setting for imitating actions and words of a patent attorney who focuses on novelty and non-obviousness of the idea to point out objection when the opinion Op(A) is generated.

Thus, the information processing system of one embodiment of the present invention can provide a constructive dialogue environment for the user of the information processing system, for example. As a result, a novel information processing system that is highly convenient, useful, or reliable can be provided.

### Configuration example 2 of information processing device

An information processing device 20 that can be used in the information processing system of one embodiment of the present invention includes, for example, an input unit 21, a storage unit 22, a processing unit 23, an output unit 24, and a transmission path 25 (see FIG. 8).

Although the block diagram in drawings attached to this specification illustrates components classified by their functions in independent blocks, it is difficult to classify actual components by their functions completely, and one component can have a plurality of functions. For example, part of the processing unit 23 functions as the input unit 21 in some cases. In addition, one function can be involved in a plurality of components. For example, processing performed in the processing unit 23 is sometimes executed by a different information processing device depending on the processing.

### Input unit 21

The input unit 21 can receive data from the outside of the information processing device. For example, the input unit 21 receives data via the network 51. Specifically, a device such as a personal computer having a communication port or a communication function can be used.

The input unit 21 supplies the received data to one or both of the storage unit 22 and the processing unit 23 via the transmission path 25.

### Storage unit 22

The storage unit 22 has a function of storing a program to be executed by the processing unit 23. The storage unit 22 can also have a function of storing data generated by the processing unit 23 (e.g., an arithmetic operation result, an analysis result, or an inference result), data received by the input unit 21, and the like.

The storage unit 22 can include a database. The information processing device can include a database in addition to the storage unit 22. The information processing device can have a function of extracting data from a database outside the storage unit 22, the information processing device, or the information processing system. Alternatively, the information processing device can have a function of extracting data from both of its own database and an external database.

One or both of a storage and a file server can be used as the storage unit 22. In addition, a database in which a path of a file stored in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a storage media drive. Examples of the storage media drive include a hard disk drive (HDD) and a solid state drive (SSD).

Note that the NOSRAM is an abbreviation for "nonvolatile oxide semiconductor random access memory (RAM)". The NOSRAM refers to a memory in which a two-transistor (2T) or three-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by using characteristics of extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for "dynamic oxide semiconductor RAM" and refers to a RAM including a one-transistor (1T) and one-capacitor (1C) memory cell. The DOSRAM is a DRAM formed using an OS transistor and temporarily stores information sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOx) or indium gallium zinc oxide (In-Ga-Zn oxide, also referred to as "IGZO") can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide included in the channel formation region may be, for example, a metal oxide that does not contain indium but contains any of zinc, gallium, and tin (e.g., zinc tin oxide and gallium tin oxide).

### Processing unit 23

The processing unit 23 has a function of performing processing such as arithmetic operation, analysis, and inference with the use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of obtaining data from the storage unit 22. The processing unit 23 can also have a function of storing or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with the use of a processor to process various kinds of data and control programs. The programs to be executed by the processor are stored in at least one of the storage unit 22 and a memory region of the processor.

The processing unit 23 can include a main memory. The main memory includes at least one of a volatile memory such as a RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the storage unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with the use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while information processed immediately before turning off the processing unit is stored in the memory element. In other words, normally-off computing is possible and the power consumption of the information processing system can be reduced.

The information processing device preferably uses AI for at least part of its processing.

In particular, the information processing device preferably uses an artificial neural network (ANN, hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, an intermediate layer (hidden layer), and an output layer.

In the description of the neural network in this specification and the like, determining a connection strength of neurons (also referred to as weight coefficients) from the existing information is referred to as "learning" in some cases.

In this specification and the like, drawing a new conclusion from a neural network formed with the connection strength obtained by learning is referred to as "inference" in some cases.

### Output unit 24

The output unit 24 can output at least one of an arithmetic operation result, an analysis result, and an inference result in the processing unit 23 to the outside of the information processing device. For example, the output unit 24 can transmit data via the network 51. Specifically, a device such as a personal computer having a communication port or a communication function can be used. Furthermore, a device having a communication function may be used as the input unit 21 and the output unit 24.

### Transmission path 25

The transmission path 25 has a function of transmitting data. Data transmission and reception between the input unit 21, the storage unit 22, the processing unit 23, and the output unit 24 can be performed via the transmission path 25. Specifically, an external bus, a LAN, or the Internet can be used for the transmission path 25.

Note that this embodiment can be combined with any of the other embodiments in this specification as appropriate.

### EMBODIMENT 2

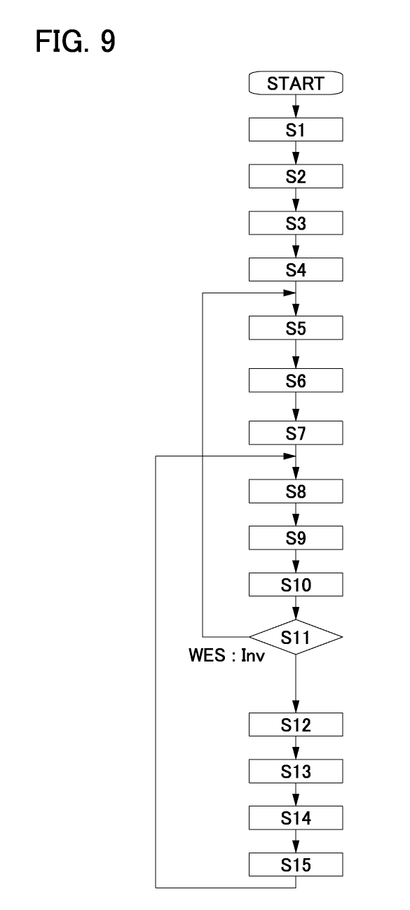

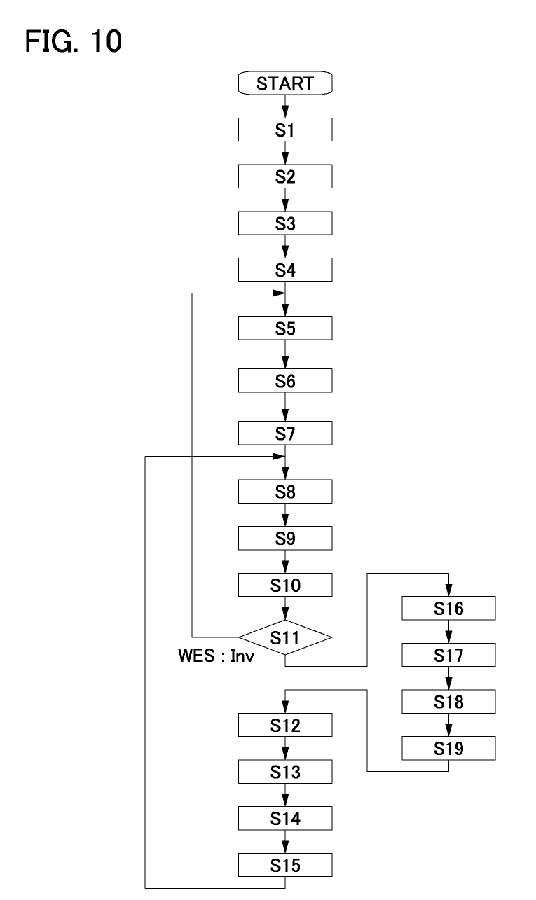

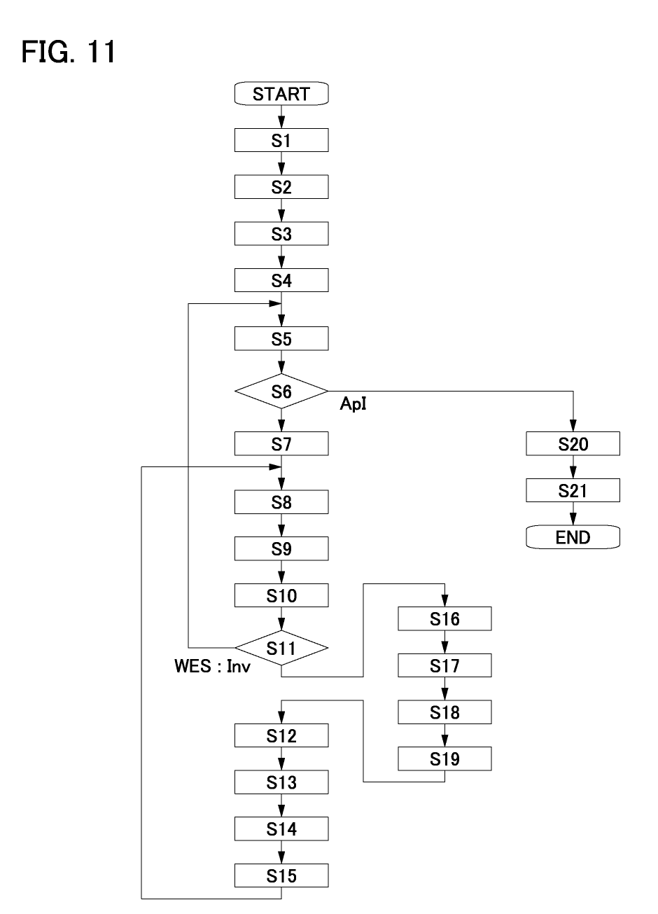

In this embodiment, an information processing method of one embodiment of the present invention will be described with reference to FIG. 9, FIG. 10, and FIG. 11.

FIG. 9 is a flow diagram showing the information processing method of one embodiment of the present invention.

FIG. 10 is a flow diagram showing the information processing method of one embodiment of the present invention.

FIG. 11 is a flow diagram showing the information processing method of one embodiment of the present invention.

### Example 1 of information processing method

An information processing method of one embodiment of the present invention includes a step S1, a step S2, a step S3, a step S4, a step S5, a step S6, a step S7, a step S8, a step S9, a step S10, a step S11, a step S12, a step S13, a step S14, and a step S15 (see FIG. 9).

### Step S1

In the step S1, the component 120 transmits the prompt Pt0 to the component 130.

The component 120 includes the subcomponent 120A. The subcomponent 120A has a function of creating the prompt Pt0.

The prompt Pt0 includes the instruction g0 and the background information BGI. The instruction g0 includes a procedure for generating the response-prompting word WES on the basis of the background information BGI to prompt the player Inv to respond. The background information BGI includes information specifying the common understanding Con and orientation of the response-prompting word WES. The common understanding Con includes a purpose of increasing patentability by extracting the idea possessing novelty and non-obviousness from the opinion Op(I) of the player Inv in collaboration with the other players.

### Step S2

In the step S2, the component 130 receives the prompt Pt0 and generates the response-prompting word WES to prompt the player Inv to respond using the large language model LLM.

### Step S3

In the step S3, the component 130 transmits the response-prompting word WES to prompt the player Inv to respond to the component 120.

### Step S4

In the step S4, the component 120 receives the response-prompting word WES to prompt the player Inv to respond and transmits it to the component 110.

### Step S5

In the step S5, the component 110 receives the response-prompting word WES to prompt the player Inv to respond and provides it to the user of the information processing system, for example.

### Example 1 of step S6

In the step S6, the component 110 receives the opinion Op(I) and transmits it to the component 120. For example, the user of the information processing system inputs the opinion Op(I) to the component 110.

### Step S7

In the step S7, the component 120 receives the opinion Op(I) and shares it in the component 120.

### Step S8

In the step S8, the subcomponent 120A creates the prompt Pt1 and transmits it to the component 130. The prompt Pt1 includes the instruction g1 and any one of the opinion Op(I), the opinion Op(P), and the opinion Op(A). The instruction g1 includes a procedure for selecting, on the basis of the background information BGI, one from the player Inv, the player Pro, and the player Ant as a target to be prompted to respond and generating the response-prompting word WES in consideration of the opinion Op(I), the opinion Op(P), or the opinion Op(A).

### Example 1 of step S9

In the step S9, the component 130 receives the prompt Pt1 and generates the response-prompting word WES using the large language model LLM.

### Example 1 of step S10

In the step S10, the component 130 transmits the response-prompting word WES to the component 120.

### Example 1 of step S11

In the step S11, the component 120 receives the response-prompting word. When the player Inv is prompted to respond with the response-prompting word, the response-prompting word is transmitted to the component 110, and the step S5 follows after the step S11.

When the player Pro is prompted to respond with the response-prompting word and when the player Ant is prompted to respond with the response-prompting word, the step S12 follows after the step S11.

### Step S12

In the step S12, the subcomponent 120A creates the prompt Pt2(P) and transmits it to the component 130 when the player Pro is prompted to respond with the response-prompting word WES. The subcomponent 120A creates the prompt Pt2(A) and transmits it to the component 130 when the player Ant is prompted to respond with the response-prompting word WES.

The prompt Pt2(P) includes the instruction g2(P), the background information BGI(P), and any one of the opinion Op(I), the opinion Op(P), and the opinion Op(A). The instruction g2(P) includes a procedure for generating a new opinion Op(P) in consideration of the opinion Op(I), the opinion Op(P), or the opinion Op(A) on the basis of the background information BGI(P). The background information BGI(P) includes information specifying the common understanding Con and orientation of the opinion Op(P).

The prompt Pt2(A) includes the instruction g2(A), the background information BGI(A), and any one of the opinion Op(I), the opinion Op(P), and the opinion Op(A). The instruction g2(A) includes a procedure for generating a new opinion Op(A) in consideration of the opinion Op(I), the opinion Op(P), or the opinion Op(A) on the basis of the background information BGI(A). The background information BGI(A) includes information specifying the common understanding Con and orientation of the opinion Op(A)

### Step S13

In the step S13, the component 130 receives the prompt Pt2(P) or the prompt Pt2(A), generates the opinion Op(P) using the large language model LLM when the player Pro is prompted to respond with the response-prompting word WES, and generates the opinion Op(A) using the large language model LLM when the player Ant is prompted to respond with the response-prompting word WES.

### Step S14

In the step S14, the component 130 transmits the opinion Op(P) or the opinion Op(A) to the component 120

### Step S15

In the step S15, the component 120 receives the opinion Op(P) or the opinion Op(A) and shares it in the component 120. The step S8 follows after the step S15.

Thus, the user of the information processing system of one embodiment of the present invention can input the opinion Op(I) to the component 110, for example. The information processing system of one embodiment of the present invention can extract the idea possessing novelty and non-obviousness from the opinion Op(I). The opinion Op(I) can be refined into the idea possessing novelty and non-obviousness. Patentability can be increased. The user of the information processing system of one embodiment of the present invention can play the role of the player Inv, for example. The player Inv can engage in dialogue with the player Pro and the player Ant. The user of the information processing system of one embodiment of the present invention can deepen user's thinking through the dialogue, for example. The information processing system of one embodiment of the present invention can extract the idea possessing novelty and non-obviousness and select one from the player Inv, the player Pro, and the player Ant to ask the selected player for the player's opinion for the purpose of increasing patentability. As a result, a novel information processing method that is highly convenient, useful, or reliable can be provided.

### Example 2 of information processing method

The above-described information processing method further includes a step S16, a step S17, a step S18, and a step S19 (see FIG. 10). The step S16, the step S17, the step S18, and the step S19 are between the step S11 and the step S12. The instruction g1 includes a procedure for generating the value V(X) corresponding to the item K(X) in consideration of the opinion Op(I), the opinion Op(P), and the opinion Op(A).

### Example 2 of step S9

In the step S9, the component 130 receives the prompt Pt1 and generates the value V(X) using the large language model LLM.

### Example 2 of step S10

In the step S10, the component 130 transmits the value V(X) to the component 120.

### Example 2 of step S11

In the step S11, the component 120 receives the value V(X) and shares it in the component 120. The step S16 follows after the step S11. The component 120 includes the subcomponent 120B.

### Step S16

In the step S16, the subcomponent 120B stores the value V(X) in the field FLD(X) and creates the specifications SS. The specifications SS include the item K(X) and the field FLD(X) corresponding to the item K(X). The item K(X) is an item required for the idea possessing novelty and non-obviousness.

### Step S17

In the step S17, the subcomponent 120B creates the dialogue record DRec. The dialogue record DRec includes the response-prompting word WES, the opinion Op(I), the opinion Op(P), and the opinion Op(A).

### Step S18

In the step S18, the subcomponent 120B shares the specifications SS and the dialogue record DRec in the component 120 and transmits them to the component 110.

### Step S19

In the step S19, the component 110 provides the specifications SS and the dialogue record DRec to the user of the information processing system, for example. The step S12 follows after the step S19.

Thus, the information processing system of one embodiment of the present invention can extract the idea possessing novelty and non-obviousness from the opinion Op(I) and format the specifications SS. As a result, a novel information processing method that is highly convenient, useful, or reliable can be provided.

### Example 3 of information processing method

The above-described information processing method further includes a step S20 and a step S21 (see FIG. 11). The step S20 and the step S21 follow after the step S6.

### Example 2 of step S6

In the step S6, the component 110 transmits the approval information ApI to the component 120 when receiving the approval information ApI. The step S20 follows after the step S6. For example, the user of the information processing system inputs the approval information ApI to the component 110.

### Step S20

In the step S20, the component 120 receives the approval information ApI and transmits the specifications SS and the dialogue record DRec to the component 110.

### Step S21

In the step S21, the component 110 provides the specifications SS and the dialogue record DRec to the user of the information processing system, for example.

Thus, the user of the information processing system can input the approval information ApI to the component 110 and terminate the dialogue with the player Pro and the player Ant, for example. As a result, a novel information processing method that is highly convenient, useful, or reliable can be provided.

Note that this embodiment can be combined with any of the other embodiments in this specification as appropriate.

This application is based on Japanese Patent Application Serial No. 2025-005904 filed with Japan Patent Office on January 16, 2025, the entire contents of which are hereby incorporated by reference.

What is claimed is:

1. An information processing system,
wherein the information processing system is configured to receive a first opinion and create a first prompt, a second prompt, a third prompt, and a fourth prompt,
wherein the information processing system is configured to receive a response-prompting word, a second opinion positive about the first opinion, and a third opinion negative about the first opinion from a large language model,
wherein the first prompt comprises a procedure for generating the response-prompting word to prompt a player to respond,
wherein the second prompt comprises a procedure for generating the response-prompting word in consideration of the first opinion, the second opinion, or the third opinion,
wherein the third prompt comprises a procedure for generating a new second opinion,
wherein the fourth prompt comprises a procedure for generating a new third opinion, and
wherein the large language model is configured to generate the response-prompting word in accordance with the first prompt and the second prompt, configured to generate the second opinion in accordance with the third prompt, and configured to generate the third opinion in accordance with the fourth prompt.

2. An information processing system comprising:
a first component;
a second component; and
a third component,
wherein the first component is configured to receive a first opinion and transmit the first opinion to the third component and configured to receive a response-prompting word,
wherein the second component is configured to receive a first prompt, a second prompt, a third prompt, and a fourth prompt,
wherein the second component is configured to transmit the response-prompting word, a second opinion, and a third opinion to the third component and configured to perform processing using a large language model,
wherein the large language model is configured to generate the response-prompting word in accordance with the first prompt and the second prompt, configured to generate the second opinion in accordance with the third prompt, and configured to generate the third opinion in accordance with the fourth prompt,
wherein the response-prompting word is a word for prompting any one of a first player, a second player, and a third player to respond,
wherein the third component is configured to receive the first opinion from the first component and transmit the first prompt, the second prompt, the third prompt, and the fourth prompt to the second component, configured to receive the response-prompting word, the second opinion, and the third opinion from the second component, and configured to transmit the response-prompting word to the first component when the first player is prompted to respond with the response-prompting word,
wherein the third component comprises a first subcomponent,
wherein the first subcomponent is configured to create the first prompt, configured to create the second prompt when the first subcomponent receives the first opinion, the second opinion, or the third opinion, configured to create the third prompt when the second player is prompted to respond with the response-prompting word, and configured to create the fourth prompt when the third player is prompted to respond with the response-prompting word,
wherein the first prompt comprises a first instruction and first background information,
wherein the first instruction comprises a procedure for generating the response-prompting word on the basis of the first background information to prompt the first player to respond,
wherein the first background information comprises information specifying common understanding and orientation of the response-prompting word,
wherein the common understanding comprises a purpose of increasing patentability by extracting an idea possessing novelty and non-obviousness from the first opinion of the first player in collaboration with the other players,
wherein the second prompt comprises a second instruction and any one of the first opinion, the second opinion, and the third opinion,
wherein the second instruction comprises a procedure for selecting, on the basis of the first background information, one from the first player, the second player, and the third player as a target to be prompted to respond and generating the response-prompting word in consideration of the first opinion, the second opinion, or the third opinion,
wherein the third prompt comprises a third instruction, second background information, and any one of the first opinion, the second opinion, and the third opinion,
wherein the third instruction comprises a procedure for generating a new second opinion in consideration of the first opinion, the second opinion, or the third opinion on the basis of the second background information,
wherein the second background information comprises information specifying the common understanding and orientation of the second opinion,
wherein the fourth prompt comprises a fourth instruction, third background information, and any one of the first opinion, the second opinion, and the third opinion,
wherein the fourth instruction comprises a procedure for generating a new third opinion in consideration of the first opinion, the second opinion, or the third opinion on the basis of the third background information, and
wherein the third background information comprises information specifying the common understanding and orientation of the third opinion.

3. The information processing system according to claim 2,
wherein the first component is configured to receive a dialogue record and specifications and provide the dialogue record and the specifications,
wherein the dialogue record comprises the response-prompting word, the first opinion, the second opinion, and the third opinion,
wherein the specifications comprise an item and a field corresponding to the item,
wherein the item is an item required for the idea possessing novelty and non-obviousness,
wherein the second component is configured to receive the second prompt and transmit a value to the third component,
wherein the large language model is configured to generate the value in accordance with the second prompt,
wherein the third component is configured to receive the value from the second component and share the value in the third component and configured to transmit the dialogue record and the specifications to the first component,
wherein the third component comprises a second subcomponent,
wherein the second subcomponent is configured to create the dialogue record and configured to store the value in the field and create the specifications, and
wherein the second instruction comprises a procedure for generating the value corresponding to the item in consideration of the first opinion, the second opinion, and the third opinion.

4. The information processing system according to claim 3,
wherein the first component is configured to receive approval information and transmit the approval information to the third component, and
wherein the third component is configured to receive the approval information and transmit the dialogue record and the specifications to the first component.

5. The information processing system according to claim 2,
wherein the third component is configured to measure elapsed time, and
wherein when the elapsed time after transmitting the response-prompting word to prompt the first player to respond to the first component overruns set time, the first subcomponent is configured to add the overrun of the set time to the first background information and create the second prompt again.

6. The information processing system according to claim 2,
wherein the third component comprises a third subcomponent,
wherein the third subcomponent is configured to perform processing using a database, configured to collect first information from the database and add the first information to the second background information, and configured to collect second information from the database and add the second information to the third background information,
wherein the first information comprises positive information on novelty or non-obviousness, and
wherein the second information comprises negative information on novelty or non-obviousness.

7. The information processing system according to claim 2,
wherein the first background information comprises a setting for imitating actions and words of a facilitator who prompts players to make remarks, summarizes their opinions, and leads to a conclusion when the response-prompting word is generated,
wherein the second background information comprises a setting for imitating actions and words of a patent attorney who focuses on novelty and non-obviousness of the idea to point out good aspects when the second opinion is generated, and
wherein the third background information comprises a setting for imitating actions and words of a patent attorney who focuses on novelty and non-obviousness of the idea to point out objection when the third opinion is generated.

8. An information processing method comprising a first step, a second step, a third step, a fourth step, a fifth step, a sixth step, a seventh step, an eighth step, a ninth step, a tenth step, an eleventh step, a twelfth step, a thirteenth step, a fourteenth step, and a fifteenth step,
wherein in the first step, a first component transmits a first prompt to a second component,
wherein the first component comprises a first subcomponent,
wherein the first subcomponent is configured to create the first prompt,
wherein the first prompt comprises a first instruction and first background information,
wherein the first instruction comprises a procedure for generating a response-prompting word on the basis of the first background information to prompt a first player to respond,
wherein the first background information comprises information specifying common understanding and orientation of the response-prompting word,
wherein the common understanding comprises a purpose of increasing patentability by extracting an idea possessing novelty and non-obviousness from a first opinion of the first player in collaboration with the other players,
wherein in the second step, the second component receives the first prompt and generates the response-prompting word to prompt the first player to respond using a large language model,
wherein in the third step, the second component transmits the response-prompting word to prompt the first player to respond to the first component,
wherein in the fourth step, the first component receives the response-prompting word to prompt the first player to respond and transmits the response-prompting word to prompt the first player to respond to a third component,
wherein in the fifth step, the third component receives the response-prompting word to prompt the first player to respond and provides the response-prompting word to prompt the first player to respond,
wherein in the sixth step, the third component receives the first opinion and transmits the first opinion to the first component,
wherein in the seventh step, the first component receives the first opinion and shares the first opinion in the first component,
wherein in the eighth step, the first subcomponent creates a second prompt and transmits the second prompt to the second component,
wherein the second prompt comprises a second instruction and any one of the first opinion, a second opinion, and a third opinion,
wherein the second instruction comprises a procedure for selecting, on the basis of the first background information, one from the first player, a second player, and a third player as a target to be prompted to respond and generating the response-prompting word in consideration of the first opinion, the second opinion, or the third opinion,
wherein in the ninth step, the second component receives the second prompt and generates the response-prompting word using the large language model,
wherein in the tenth step, the second component transmits the response-prompting word to the first component,
wherein in the eleventh step, the first component receives the response-prompting word,
wherein when the first player is prompted to respond with the response-prompting word, the response-prompting word is transmitted to the third component, and the fifth step follows after the eleventh step,
wherein when the second player is prompted to respond with the response-prompting word and when the third player is prompted to respond with the response-prompting word, the twelfth step follows after the eleventh step,
wherein in the twelfth step, the first subcomponent creates a third prompt and transmits the third prompt to the second component when the second player is prompted to respond with the response-prompting word, and the first subcomponent creates a fourth prompt and transmits the fourth prompt to the second component when the third player is prompted to respond with the response-prompting word,
wherein the third prompt comprises a third instruction, second background information, and any one of the first opinion, the second opinion, and the third opinion,
wherein the third instruction comprises a procedure for generating a new second opinion in consideration of the first opinion, the second opinion, or the third opinion on the basis of the second background information,
wherein the second background information comprises information specifying the common understanding and orientation of the second opinion,
wherein the fourth prompt comprises a fourth instruction, third background information, and any one of the first opinion, the second opinion, and the third opinion,
wherein the fourth instruction comprises a procedure for generating a new third opinion in consideration of the first opinion, the second opinion, or the third opinion on the basis of the third background information,
wherein the third background information comprises information specifying the common understanding and orientation of the third opinion,
wherein in the thirteenth step, the second component receives the third prompt or the fourth prompt, generates the second opinion using the large language model when the second player is prompted to respond with the response-prompting word, and generates the third opinion using the large language model when the third player is prompted to respond with the response-prompting word,
wherein in the fourteenth step, the second component transmits the second opinion or the third opinion to the first component, and
wherein in the fifteenth step, the first component receives the second opinion or the third opinion and shares the second opinion or the third opinion in the first component, and
wherein the eighth step follows after the fifteenth step.

9. The information processing method according to claim 8, further comprising a sixteenth step, a seventeenth step, an eighteenth step, and a nineteenth step,
wherein the second instruction comprises a procedure for generating a value corresponding to an item in consideration of the first opinion, the second opinion, and the third opinion,
wherein the sixteenth step, the seventeenth step, the eighteenth step, and the nineteenth step are between the eleventh step and the twelfth step,
wherein in the ninth step, the second component receives the second prompt and generates the value using the large language model,
wherein in the tenth step, the second component transmits the value to the first component,
wherein in the eleventh step, the first component receives the value and shares the value in the first component,
wherein the sixteenth step follows after the eleventh step,
wherein the first component comprises a second subcomponent,
wherein in the sixteenth step, the second subcomponent stores the value in a field and creates specifications,
wherein the specifications comprise the item and the field corresponding to the item,
wherein the item is an item required for the idea possessing novelty and non-obviousness,
wherein in the seventeenth step, the second subcomponent creates a dialogue record,
wherein the dialogue record comprises the response-prompting word, the first opinion, the second opinion, and the third opinion,
wherein in the eighteenth step, the second subcomponent shares the specifications and the dialogue record in the first component and transmits the specifications and the dialogue record to the third component, and
wherein in the nineteenth step, the third component provides the specifications and the dialogue record, and
wherein the twelfth step follows after the nineteenth step.

10. The information processing method according to claim 9, further comprising a twentieth step and a twenty-first step,
wherein the twentieth step and the twenty-first step follow after the sixth step,
wherein in the sixth step, the third component transmits approval information to the first component when the third component receives the approval information,
wherein the twentieth step follows after the sixth step,
wherein in the twentieth step, the first component receives the approval information and transmits the specifications and the dialogue record to the third component, and
wherein in the twenty-first step, the third component provides the specifications and the dialogue record.
